(19) United States
(12) Patent Application Publication
(10) Pub. No.: US 2004/0013405 A1
(43) Pub. Date: Jan. 22, 2004

(54) Method for preparing/printing video scene indices

(76) Inventor: Robert D. Christiansen, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/199,844

(22) Filed: Jul. 18, 2002

(51) Int. Cl. H04N 5/783; G11B 27/00

(52) U.S. Cl. 386/69; 386/70

(57) ABSTRACT

This invention relates to a method for preparing/printing video scene indices from a variety of video types. Such methods of this type, generally, allow the user to prepare/print a video scene index from a video so that the user does not have to view the entire video in order to determine what is on the video. The index can also be stored at the beginning or end of the video so that the index cannot be misplaced or lost.

### FIELD OF THE INVENTION

This invention relates to a method for preparing/printing video scene indices from a variety of video types. Such methods of this type, generally, allow the user to prepare/print a video scene index from a video so that the user does not have to view the entire video in order to determine what is on the video. The index can also be stored at the beginning or end of the video so that the index cannot be misplaced or lost.

### DESCRIPTION OF THE RELATED ART

Prior to the present invention, as set forth in general terms above and more specifically below, it is known, that many households have a number of unlabeled video and camcorder tapes. Due to this, the user does not usually have any idea of what is actually on the tapes. Consequently, a more advantageous system, then, would be presented if the unlabeled tapes could be provided with an index that would inform the user as to what is on the unlabeled tapes.

It is also known, in the photograph developing art, to prepare an index of the photographs developed from a roll of film. While the index is helpful in determining which photographs came from which roll of film, a roll of film contains a discrete number of photographs or scenes. Conversely, a video on a video tape or other similar types of devices that can contain a video, could be comprised of an almost infinite number of photographs or scene changes. Therefore, an even more advantageous system, then, would be presented if the system were able to provide an index of the video scene changes in a video tape or other similar type of device.

It is further known, in the video art, to create a slide presentation from a full motion video. Exemplary of such prior art is U.S. Pat. No. 6,342,904 ('904) to V.V. Vasudevan et al., entitled “Creating a Slide Presentation From Full Motion Video.” While the '904 reference teaches a method for preparing a slide presentation from a full motion video, this system selects the slide to be used in presentation based upon a certain time interval. For example, the displayable video picture frames located one minute from each other in the full motion video will be used to prepare the slide presentation. Even if the scene never changes, the time interval will be strictly observed. Consequently, the slide presentation may include several slides showing the same basic scene. Also, the '904 reference does not teach the method of printing out an index of the various slides used in slide presentation. Therefore, a still further advantageous system, then, would be presented if the system were able to accurately detect scene changes in the video and provide an index of the scene changes for later reference.

It is apparent from the above that there exists a need in the art for a video indexing system which is capable of providing an index of the video, and which is capable of printing/storing a copy of the index, but which at the same time is capable of detecting scene changes in the video. It as a purpose of this invention to fulfill this and other needs in the art in a manner more apparent to the skilled artisan once given the following disclosure.

### SUMMARY OF THE INVENTION

Generally speaking, this invention fulfills these needs by providing a method for preparing a video scene index from a video, wherein the method is comprised of the steps of: obtaining a copy of a video; playing the video on a video viewing device; dividing each video picture frame in the video into a plurality of segments; sampling each of the segments to determine a pixel change; determining if a desired pixel change has occurred in a segment; storing a copy of the video picture frame once the desired pixel change has occurred; and preparing an index of substantially all the stored video picture frame copies.

In certain preferred embodiments, the video can be located on a video tape, camcorder, video recorder, digital camera or the like or stored as a file on a computer. Also, the video viewing device can be, but is not limited to, a video cassette recorder or the like. Also, if, for example, at least fifty percent of pixels in a particular segment change, it could be inferred that a scene change has occurred. Also, a certain time interval is taken into account in order to avoid the effects of video jitter. Finally, the index can be printed. Also, the index can be stored on the video tape, camcorder, video recorder, digital camera or the like. Also, the index can be stored on the video viewing device or a computer.

In another further preferred embodiment, a software method for recognizing scene transitions is utilized. The method would monitor a set of regions on the displayable video. These regions would measure the pixel changes that occurred within the region from video frame to video frame for a minimum time interval. If a certain percentage of pixels change from one frame to the next frame, then the region is considered to be a “changed” region. If enough regions change, then a new scene has been discovered. It is to be understood that the method could monitor, for example, an 8-way shifting of pixels in case the scene was being panned, in order to determine if a new scene has been discovered. In this manner, if a monitored pixel has shifted by a user's predetermined amount, a new scene should have occurred.

The preferred indexing system, according to this invention, offers the following advantages: excellent scene change recognition; excellent segment monitoring characteristics; excellent pixel monitoring characteristics; ability to provide different types of indices; and excellent economy. In fact, in many of the preferred embodiments, these factors of scene change recognition, segment monitoring characteristics, pixel monitoring characteristics, and ability to provide different types of indices are optimized to an extent that is considerably higher than heretofore achieved in prior, known indexing systems.

The above and other features of the present invention, which will become more apparent as the description proceeds, are best understood by considering the following detailed description in conjunction with the accompanying drawings, wherein like characters represent like parts throughout the several views and in which:

### BRIEF DESCRIPTION OF THE DRAWINGS

FIGS. 1a and 1b are flowcharts that illustrate a method for preparing a video scene index from a video, according to one embodiment of the present invention.

### DETAILED DESCRIPTION OF THE INVENTION

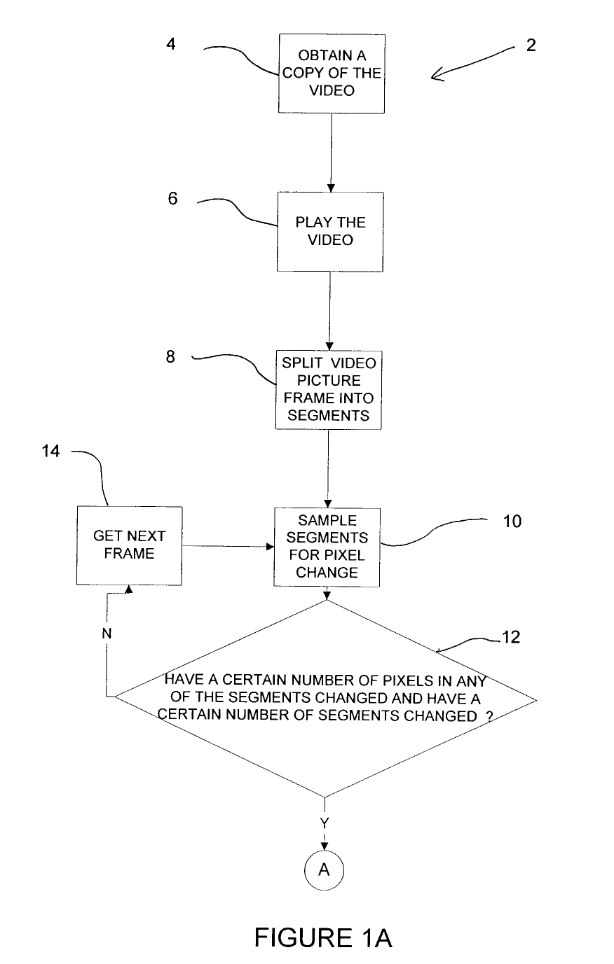

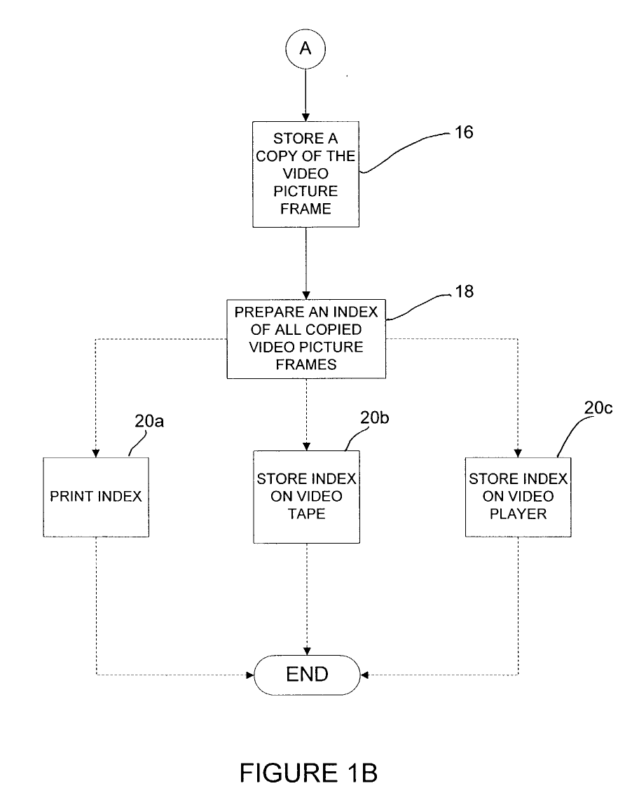

With reference to FIGS. 1a and 1b, there is illustrated one preferred embodiment for use of the concepts of this invention. FIGS. 1a and 1b illustrate method 2 for preparing a video scene index from a video. Method 2 includes, in part, the steps of: obtaining a copy of the video (step 4); playing the video (step 6); splitting the displayed video picture frame into a plurality of segments or regions (step 8); sampling the plurality of segments or regions for a pixel change from one displayed video picture frame to the next displayed video picture frame (step 10); determining if a certain percentage of pixels have changed from one displayed video picture frame to the next displayed video picture frame (step 12); getting the next frame (step 14); storing a copy of the video picture frame (step 16);preparing an index of all copied displayed video picture frames (step 18); and printing the index (step 20a) or storing the index on the video tape (step 20b ) or storing the index on the video player (step 20c).

With respect to step 4, the video can be located on a video tape, camcorder, video recorder, digital camera, computer or any other suitable device which is capable of storing a video.

With respect to step 6, the video can be played upon a video cassette recorder or any other any suitable device which is capable of playing the video and, possibly, storing a copy of the video scene index and subsequently recognizing the unique identifier of that particular video scene index, which is to be discussed later.

With respect to step 8, each displayable video picture frame would be conventionally divided into segments or regions. For example, each displayable video picture frame could be divided into four segments or quadrants through the use of pixel counting in X and Y directions and dividing each side by some constant that is changeable by the user. It is to be understood that the displayed video picture frame could be divided into an infinite number of segments or regions depending upon the desired size of the sampling segment or region.

With respect to step 10, each one of the segments or regions of the displayed video picture frame is sampled or measured, for example, by comparing a color change of each pixel to determine if pixel changes have occurred from one displayed video picture frame to the next frame.

With respect to step 12, as the displayable video picture frames are sampled or measured in the for pixel changes, a determination/calculation is made as to whether or not a minimum number of pixels in a particular segment or region have changed from one displayable video picture frame to the next frame. For example, it may be determined that when a minimum (X) percent of the pixels have changed in a segment or region from one displayable video picture frame to the next frame, a “change ” in the segment or region may have occurred and a new scene may have been discovered. It is also to be understood that if a minimum number (Y) of segments or regions have “changed”, then a new scene may also have been discovered. For example, it may be determined that if two of the four segments or regions have experienced a “change”, then a new scene should have occurred. It is to be further understood that the user can set up the minimum numbers (X) and (Y) to determine when scene changes have occurred. Finally, it is to be understood that the method could monitor, for example, an 8-way shifting of pixels in case the scene was being panned, in order to determine if a new scene has been discovered. In this manner, if a monitored pixel has shifted by a user's predetermined amount, a new scene should have occurred.

With respect to step 14, the next frame is viewed for pixel change, as discussed above,

With respect to step 16, once a new scene has been discovered, a copy of the first displayable video picture frame that is being viewed by the video player is conventionally stored either internal or external to video player. For example, if at displayed video picture frame 200, a new scene has been discovered, then a copy of frame 200 would be stored. However, it is to be understood that a minimum time interval will be observed in order to account for jitter in the video. If jitter occurs in the video, a new scene may be detected at every displayable video picture frame or every few displayable video picture frames even if the actual scene on the video never changes. If, for example, a minimum of 10 seconds between scene changes is observed, this should eliminate the adverse effects of jitter on the scene indexing capabilities of the present invention. In short, the present invention will look for scene changes, but will only save copies of the scene change for indexing purposes once the minimum time interval has passed.

With respect to step 18, after the entire video has been viewed by the video player, an index/collection of all the copied/stored displayed video picture frames is prepared. For example, a copy of the index can be conventionally printed out (step 20a) or a copy of the index can be stored at the beginning or end of the video (step 20b) or a copy of the index can be conventionally stored in the video player (step 20c).

It is to be understood that the purpose of the index is to provide a unique identifier of the video. For example, the first five displayed video picture frames or other such suitable number of frames can be stored at the beginning or end of the video (step 20b) or in the video player (step 20c). In this manner, when the video is played in the video player, the video player can scan the video to review the index and determine if the video player has previously played this particular video. This could be particularly useful if the user is storing videos in the video player. The review of the index by the video player would allow the video player to alert the user to the possibility that this particular video may have been already stored in the video player.

Once given the above disclosure, many other features, modifications or improvements will become apparent to the skilled artisan. Such features, modifications or improvements are, therefore, considered to be a part of this invention, the scope of which is to be determined by the following claims.

What is claimed is:

1. A method for preparing a video scene index from a video, comprising the steps of:
obtaining a copy of a video;
playing said video on a video viewing device;
dividing each video picture frame in said video into a plurality of segments;
sampling each of said segments to determine a pixel change;
determining if a desired pixel change has occurred in a segment;
storing a copy of said video picture frame once said desired pixel change has occurred; and
preparing an index of substantially all said stored video picture frame copies.

2. The method, as in claim 1, wherein said video copy is obtained from a video tape.

3. The method, as in claim 1, wherein said video copy is obtained from a camcorder.

4. The method, as in claim 1, wherein said video copy is obtained from a video recorder.

5. The method, as in claim 1, wherein said video copy is obtained from a digital camera.

6. The method, as in claim 1, wherein said video copy is obtained from a computer.

7. The method, as in claim 1, wherein said determining step is further comprised of the step of:
determining that a minimum percent of said pixels in a segment have changed.

8. The method, as in claim 1, wherein said determining step is further comprised of the step of:
determining that a minimum percent of said segments have changed.

9. The method, as in claim 1, wherein said determining step is further comprised of the step of:
determining if a pixel has shifted by a pre-determined amount.

10. The method, as in claim 1, wherein said preparing step is further comprised of the step of:
printing a copy of said index.

11. The method, as in claim 2, wherein said preparing step is further comprised of the step of:
storing a copy of said index on said video tape.

12. The method, as in claim 1, wherein said preparing step is further comprised of the step of:
storing a copy of said index on a video player.

13. The method, as in claim 1, wherein said sampling step is further comprised of step of:
sampling for a minimum time interval.

14. A program storage medium readable by a computer, tangibly embodying a program of instructions executable by said computer to perform method steps for preparing a video scene index from a video, comprising the steps of:
obtaining a copy of a video;
playing said video on a video viewing device;
dividing each video picture frame in said video into a plurality of segments;
sampling each of said segments to determine a pixel change;
determining if a desired pixel change has occurred in a segment;
storing a copy of said video picture frame once said desired pixel change has occurred; and
preparing an index of substantially all said stored video picture frame copies.

15. The method, as in claim 14, wherein said video copy is obtained from a video tape.

16. The method, as in claim 14, wherein said video copy is obtained from a camcorder.

17. The method, as in claim 14, wherein said video copy is obtained from a video recorder.

18. The method, as in claim 14, wherein said video copy is obtained from a digital camera.

19. The method, as in claim 14, wherein said video copy is obtained from a computer.

20. The method, as in claim 14, wherein said determining step is further comprised of the step of:
determining that a minimum percent of said pixels in a segment have changed.

21. The method, as in claim 14, wherein said determining step is further comprised of the step of:
determining that a minimum percent of said segments have changed.

22. The method, as in claim 14, wherein said determining step is further comprised of the step of:
determining if a pixel has shifted by a pre-determined amount.

23. The method, as in claim 14, wherein said preparing step is further comprised of the step of:
printing a copy of said index.

24. The method, as in claim 15, wherein said preparing step is further comprised of the step of:
storing a copy of said index on said video tape.

25. The method, as in claim 14, wherein said preparing step is further comprised of the step of:
storing a copy of said index on a video player.

26. The method, as in claim 14, wherein said sampling step is further comprised of step of:
sampling for a minimum time interval.

27. A processor enabled to perform the method steps for:
obtaining a copy of a video;
playing said video on a video viewing device;
dividing each video picture frame in said video into a plurality of segments;
sampling each of said segments to determine a pixel change;
determining if a desired pixel change has occurred in a segment;
storing a copy of said video picture frame once said desired pixel change has occurred; and
preparing an index of substantially all said stored video picture frame copies.

28. The method, as in claim 27, wherein said video copy is obtained from a video tape.

29. The method, as in claim 27, wherein said video copy is obtained from a camcorder.

30. The method, as in claim 27, wherein said video copy is obtained from a video recorder.

31. The method, as in claim 27, wherein said video copy is obtained from a digital camera.

32. The method, as in claim 27, wherein said video copy is obtained from a computer.

33. The method, as in claim 27, wherein said determining step is further comprised of the step of:
determining that a minimum percent of said pixels in a segment have changed.

34. The method, as in claim 27, wherein said determining step is further comprised of the step of:
determining that a minimum percent of said segments have changed.

35. The method, as in claim 27, wherein said determining step is further comprised of the step of:
determining if a pixel has shifted by a pre-determined amount.

36. The method, as in claim 27, wherein said preparing step is further comprised of the step of:
printing a copy of said index.

37. The method, as in claim 28, wherein said preparing step is further comprised of the step of:
storing a copy of said index on said video tape.

38. The method, as in claim 27, wherein said preparing step is further comprised of the step of:
storing a copy of said index on a video player.

39. The method, as in claim 27, wherein said sampling step is further comprised of step of:
sampling for a minimum time interval.
